(19) United States
(12) Patent Application Publication
(10) Pub. No.: US 2008/0187139 A1
(43) Pub. Date: Aug. 7, 2008

(54) SEMICONDUCTOR DEVICE, SMART CARD, AND ELECTRNOIC APPARATUS

(75) Inventor: Isao AKIMA, Ogaki (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/026,581

(22) Filed: Feb. 6, 2008

(30) Foreign Application Priority Data
Feb. 7, 2007 (JP) 2007-027651

(51) Int. Cl. H04L 9/00

(52) U.S. Cl. 380/277

(57) ABSTRACT

A semiconductor device includes: a rewritable ferroelectric memory including an encryption table containing one or more data codes paired with encryption codes that are the data codes encrypted, a first region for storing the encryption codes, a second region for storing the data codes, and a third region for storing one or more of the data codes, wherein, when the encryption code is stored in the first region, the encryption table is searched through and the data code pairing with the encryption code is outputted to the second region, and when the data code is stored in the second region, the encryption table is searched through and the encryption code paring with the data code is outputted to the first region; a reception section that receives from outside a command code and the encryption code; and a transmission section that transmits outside the encryption code, wherein, upon receiving from outside a write command as the command code and the encryption code at the reception section, the encryption code received is inputted to the first region, and the data code paired with the encryption code outputted from the second region is written to the third region; and upon receiving from outside a readout command as the command code at the reception section, a specified one of the data codes is read from the third region and inputted to the second region, the encryption code paired with the data code outputted from the first region is transferred to the transmission section, and the encryption code is transmitted outside from the transmission section.

The entire disclosure of Japanese Patent Application No. 2007-027651, filed Feb. 7, 2007 is expressly incorporated by reference herein.

### BACKGROUND

1. Technical Field

The invention relates to semiconductor devices, smart cards and electronic apparatuses, which are provided with security functions.

2. Related Art

In recent years, significant changes from magnetic card type credit cards to IC chip embedded type credit cards have been taking place. IC chip embedded type credit cards can each store a large amount of personal information in a flash memory of their IC chip. However, there is a danger that the stored information may be read from outside if the information is stored without being encrypted.

To address the issue described above, for example, a non-patent document, a product catalog FIJ002-03-0609 by Sony Corporation for RC-S953/3MV (http://www.sony.co.jp/Products/felica/pdf/data/RC-S952_S953_J.pdf) describes a method for encrypting and storing personal information by using an embedded encryption/decryption processing circuit (Crypt Engine) 300 for encrypting and decrypting data, as shown in FIG. 8.

However, according to the non-patent document described above, the encryption/decryption processing circuit 300 includes a ROM 140 that stores an encryption correspondence table and a logic circuit for decrypting encryption codes. The encryption correspondence table can be relatively easily decrypted by examining wirings of the ROM 140. Also, to update the encryption correspondence table, the encryption/decryption processing circuit 300 must be re-built.

### SUMMARY

An advantage of some aspects of the invention, semiconductor devices, smart cards and electronic apparatuses are provided with a code correspondence table that can be readily updated and cannot be decrypted from outside.

A semiconductor device in accordance with an embodiment of the invention includes: a rewritable ferroelectric memory including an encryption table containing one or more data codes paired with encryption codes that are the data codes encrypted, a first region for storing the encryption codes, a second region for storing the data codes, and a third region for storing one or more of the data codes, wherein, when the encryption code is stored in the first region, the encryption table is searched through and the data code pairing with the encryption code is outputted to the second region, and when the data code is stored in the second region, the encryption table is searched through and the encryption code paring with the data code is outputted to the first region; a reception section that receives from outside a command code and the encryption code; and a transmission section that transmits outside the encryption code, wherein, upon receiving from outside a write command as the command code and the encryption code at the reception section, the encryption code received is inputted to the first region, and the data code paired with the encryption code outputted from the second region is written to the third region; and upon receiving from outside a readout command as the command code at the reception section, a specified one of the data codes is read from the third region and inputted to the second region, the encryption code paired with the data code outputted from the first region is transferred to the transmission section, and the encryption code is transmitted outside from the transmission section.

According to the composition described above, the encryption table is written in the ferroelectric memory that is rewritable at very high speeds, such that it is easy to continue properly rewriting the encryption table relation at high speeds with the cache function of the encryption table between the encryption table and the storage memory according to the encryption rule of the encryption table itself, and the stored data and stored data history (including encryption key or decryption key information) stored in the ferroelectric memory can be continuously rewritten. Therefore, there is in effect no risk of the encryption table stored in the ferroelectric memory being decrypted from outside. Even if the data were artificially decrypted temporarily for unauthorized use, the encryption table relation can be repeatedly recovered to the state where the encryption table itself should originally be by the cache function of the encryption table given between the encryption table and the storage memory, such that the encryption table that is about to be misused would be overwritten, and therefore there is no danger of the encryption table stored in the ferroelectric memory being continuously misused from outside. Further, when the occurrence of a condition in which the encryption table and stored data relation cannot be established due to malicious intent is detected, the characteristics of the ferroelectric memory may be used thereby stopping the use of the encryption table itself. Accordingly, the invention can provide a function to stop and prevent misuse of the device.

A semiconductor device in accordance with an embodiment of the invention includes: a rewritable ferroelectric memory including an encryption table containing one or more data codes paired with encryption codes that are the data codes encrypted, a first region for storing the encryption codes, a second region for storing the data codes, and a third region for storing one or more of the encryption codes, wherein, when the encryption code is stored in the first region, the encryption table is searched through and the data code pairing with the encryption code is outputted to the second region, and when the data code is stored in the second region, the encryption table is searched through and the encryption code paring with the data code is outputted to the first region; a reception section that receives from outside a command code and the data code; and a transmission section that transmits outside the data code, wherein, upon receiving from outside a write command as the command code and the data code at the reception section, the data code received is inputted to the second region, and the encryption code paired with the data code outputted from the first region is written to the third region; and upon receiving from outside a readout command as the command code at the reception section, a specified one of the encryption codes is read from the third region and inputted to the first region, the data code paired with the encryption code outputted from the second region is transferred to the transmission section, and the data code is transmitted outside from the transmission section.

According to the composition described above, the encryption table is written in the ferroelectric memory that is rewritable at very high speeds, such that it is easy to continue properly rewriting the encryption table relation at high speeds with the cache function of the encryption table between the encryption table and the storage memory according to the encryption rule of the encryption table itself, and the stored data and stored data history (including encryption key or decryption key information) stored in the ferroelectric memory can be continuously rewritten. Therefore, there is in effect no risk of the encryption table stored in the ferroelectric memory being decrypted from outside. Even if the data were artificially decrypted temporarily for unauthorized use, the encryption table relation can be repeatedly recovered to the state where the encryption table itself should originally be by the cache function of the encryption table given between the encryption table and the storage memory, such that the encryption table that is about to be misused would be overwritten, and therefore the encryption table stored in the ferroelectric memory would not possibly be continuously misused from outside. Further, when the occurrence of a condition in which the encryption table and stored data relation cannot be established due to malicious intent is detected, the characteristics of the ferroelectric memory may be used thereby stopping the use of the encryption table itself. Accordingly, the invention can provide a function to stop and prevent misuse of the device.

A semiconductor device in accordance with an aspect of the embodiment of the invention may include an error correction circuit that corrects an error that possibly occurs on data stored in the ferroelectric memory.

By the composition described above, when an encryption code that is transferred to the first region of the ferroelectric memory has an error, there is no danger of malfunction because the error is corrected.

Moreover, a smart card in accordance with an embodiment of the invention includes one of the semiconductor devices described above.

Furthermore, an electronic apparatus in accordance with an embodiment of the invention includes the smart card described above.

### BRIEF DESCRIPTION OF THE DRAWINGS

FIG. 1 is a schematic block diagram of the structure of a smart card in accordance with a first embodiment of the invention.

FIGS. 2A and 2B show diagrams for describing the composition of an encryption table.

FIG. 3 is a block diagram for describing an operation to write encryption codes.

FIG. 4 is a block diagram for describing an operation to read encryption codes.

FIG. 5 is a block diagram for describing an operation to write data codes.

FIG. 6 is a block diagram for describing an operation to read data codes.

FIG. 7 is a block diagram for describing an operation to rewrite the encryption table.

FIG. 8 is a schematic block diagram of the structure of a smart card in related art.

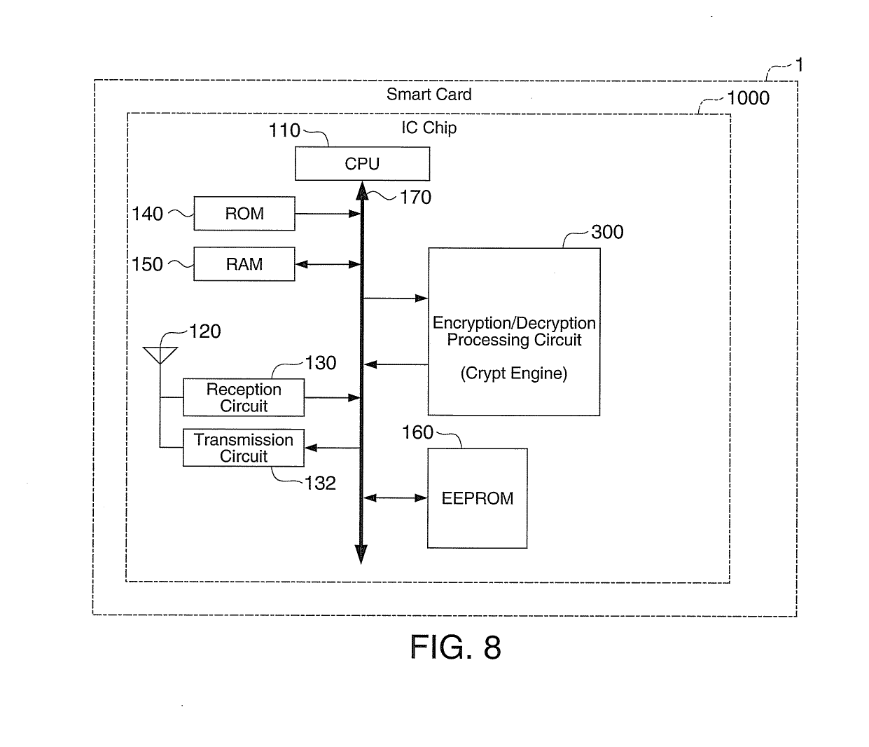

### DESCRIPTION OF EXEMPLARY EMBODIMENTS

Preferred embodiments of the invention are described below with reference to the accompanying drawings.

### First Embodiment

Structure of Smart Card

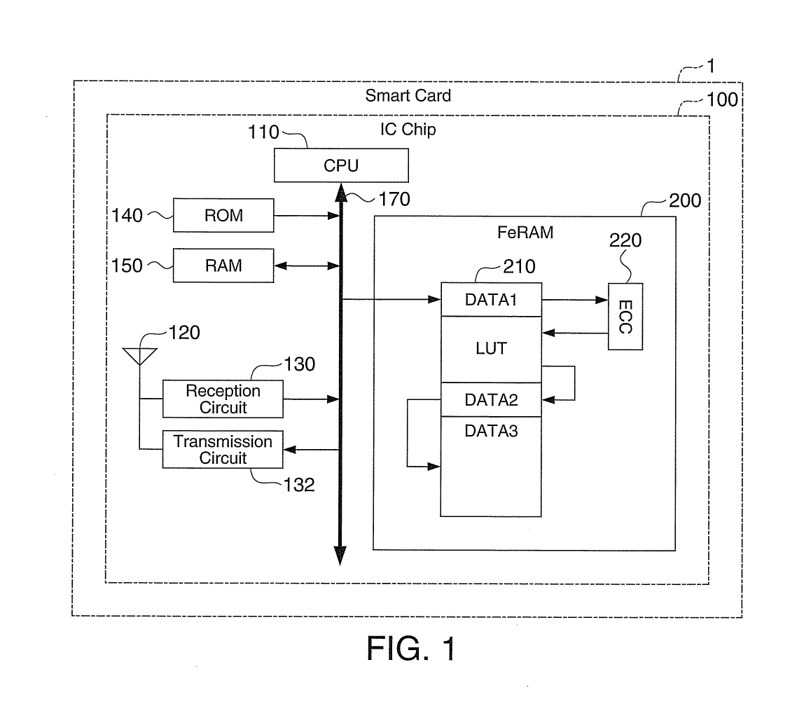

First, the structure of a smart card in accordance with the first embodiment is described with reference to FIG. 1. FIG. 1 is a schematic block diagram of the structure of the smart card in accordance with the first embodiment of the invention. As shown in FIG. 1, the smart card 1 includes an IC chip 100 that is a semiconductor device.

The IC chip 100 is formed from a central processing unit (CPU) 110, a ROM 140 that stores a program to be executed by the CPU 110, a RAM 150 to which the CPU 110 temporarily writes data upon its execution, an antenna 120 for transmission of signals and reception of signals from outside, a reception circuit 130 that is a reception section, a transmission circuit 132 that is a transmission section, a FeRAM (Ferroelectric Random Access Memory) 200 that is a ferroelectric memory, and an internal bus 170.

The FeRAM 200 includes a data storage region 210 and an error correction circuit (ECC: Error Correction Code) 220. Also, an encryption table LUT (Lookup Table) for decoding encryption codes to data codes is written in the data storage region 210. The data storage region 210 further includes a region DATA1 that is a first region for storing an encryption code, a region DATA2 that is a second region for storing a data code, and a region DATA3 that is a third region for storing one or more data codes.

The FeRAM 200 is a type of a nonvolatile memory using a ferroelectric. The ferroelectric is a dielectric material (a substance that stores a charge by polarization and does not flow a direct current) whose orientation of spontaneous polarization (a phenomenon in which electrically positive or negative state occurs in the substance) can be freely changed by the application of a voltage, and its orientation of polarization can be continually maintained without the application of a voltage. Furthermore, the FeRAM 200 is capable of high-speed reading and writing 10 times or higher than a flash memory, and its reliability is said to be considerably higher than flash memories and EEPROM (Electronically Erasable and Programmable Read Only Memory).

The FeRAM 200 has advantages such as high-speed access capability, high reliability and nonvolatility in which data is stored without the application of a voltage, as described above. Furthermore, a ferroelectric is used as a memory element, stored data would be destroyed if the data is carelessly read out, which makes the data difficult to be read from outside. For this reason, high security and reliability can be provided by writing the encryption table LUT for decoding encryption codes in the data storage region 210 of the FeRAM 200.

Structure of LUT

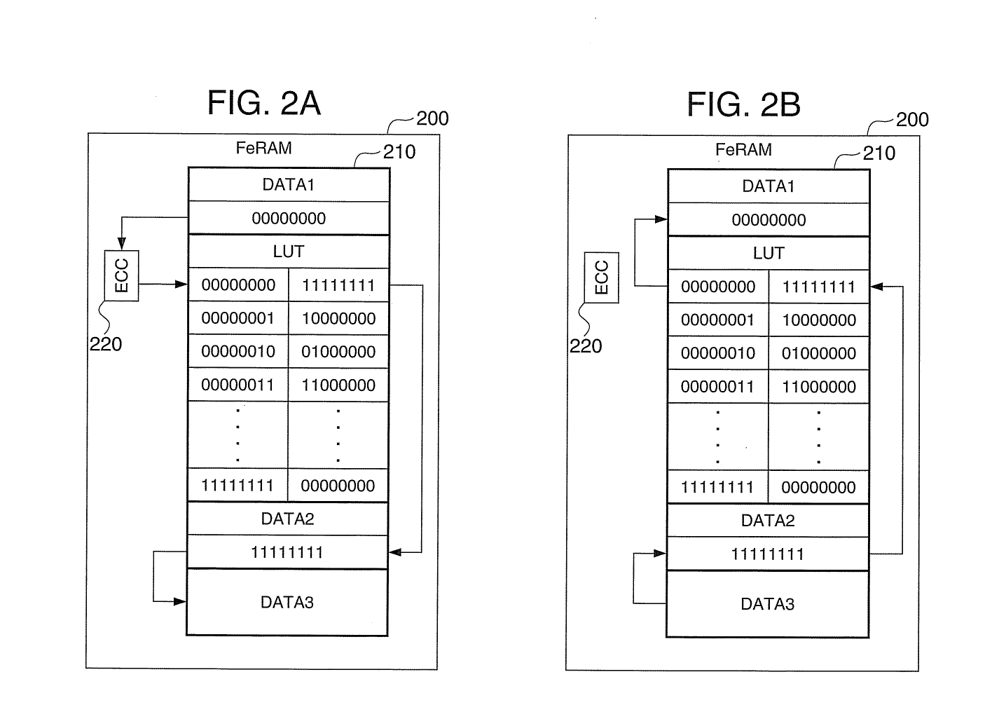

The structure of the encryption table LUT is described below with reference to FIGS. 2A and 2B. FIGS. 2A and 2B are diagrams for describing the composition of the encryption table LUT. FIG. 2A shows the composition showing operations in which an encryption code is decoded to a data code, and FIG. 2B shows the composition showing operations in which a data code is encrypted to an encryption code. It is noted that numerical values shown in FIGS. 2A and 2B indicate an embodiment example of simple encryption.

As shown in FIGS. 2A and 2B, the data storage region 210 of the FeRAM 200 includes the encryption table LUT, the region DATA1, the region DATA2 and the region DATA3. The encryption table LUT has rows, and each of the rows has two regions, wherein the region on the left side stores an encryption code and the region on the right side stores a data code paired to the encryption code.

When decoding an encryption code to a data code, as shown in FIG. 2A, the encryption code is stored in the region DATA1, the encryption code stored in the region DATA1 is first checked with ECC 220 if it is correct, and when it is correct, a matching encryption code is searched through the left side regions of the encryption table LUT. When the matching encryption code is found, a data code in the right side regions to be paired with the encryption code is written out to the region DATA2.

When encrypting a data code to an encryption code, as shown in FIG. 2B, the data code is stored in the region DATA2, and a matching data code is searched through the right side regions of the encryption table LUT. When the matching data code is found, an encryption code in the left side regions to be paired with the data code is written to the region DATA1.

Operation to Write Encryption Code

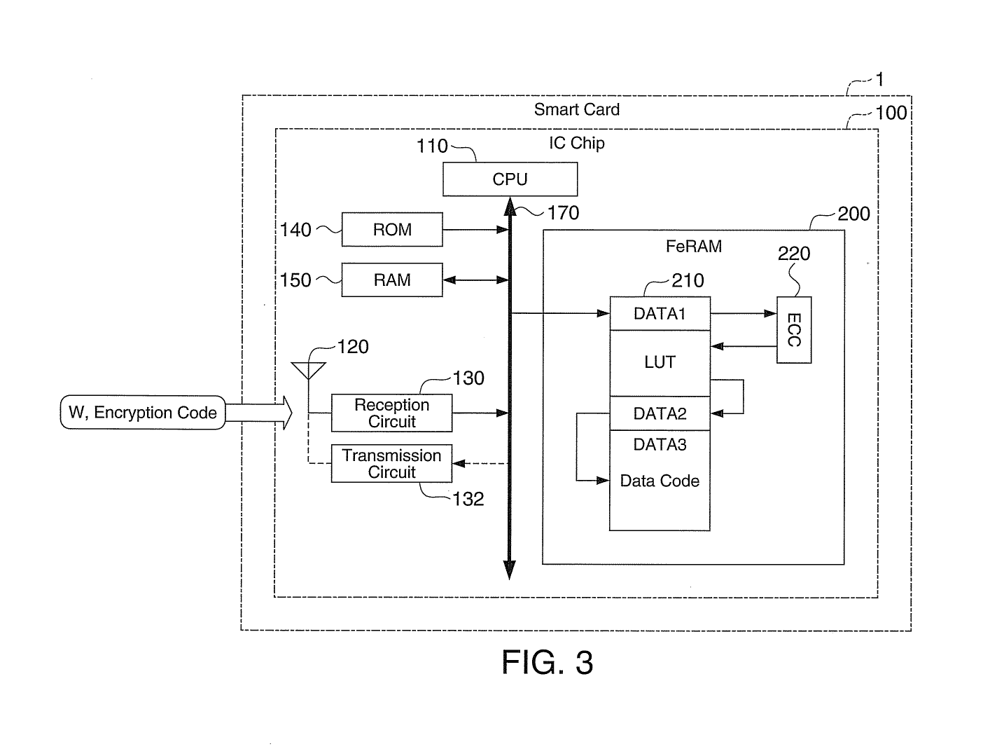

Next, an operation to write an encryption code is described with reference to FIG. 3. FIG. 3 is a block diagram for describing an operation to write an encryption code.

As shown in FIG. 3, when a write command W and an encryption code are sent from outside, the encryption code is transferred and stored in the region DATA1 of the data storage region 210 of the FeRAM 200 through the antenna 120, the reception circuit 130 and the internal bus 170. The encryption code stored in the region DATA1 is checked with ECC 220 if it is correct, and when it is correct, a matching encryption code is searched through the left side regions of the encryption table LUT. When the matching encryption code is found, a data code to be paired with in the right side regions is stored in the region DATA2. The data code stored in the region DATA2 is sequentially written to the region DATA3.

Operation to Read Encryption Code

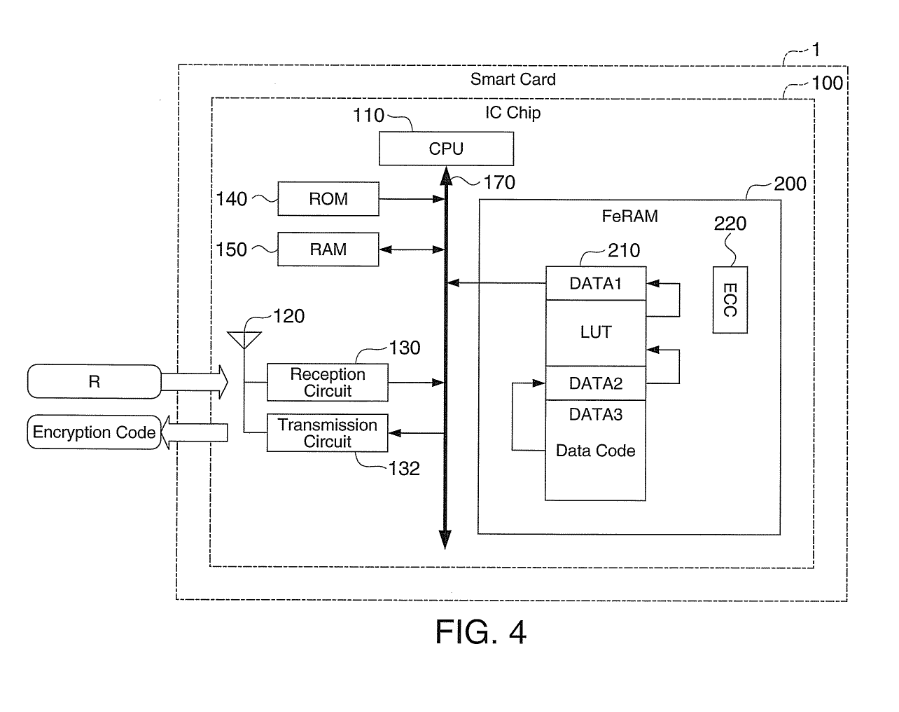

Next, an operation to read an encryption code is described with reference to FIG. 4. FIG. 4 is a block diagram for describing an operation to read an encryption code.

As shown in FIG. 4, when a readout command R is sent from outside, the readout command R is transferred through the antenna 120, the reception circuit 130 and the internal bus 170, and interpreted by the CPU 110. Then data codes stored in the region DATA3 of the data storage region 210 of the FeRAM 200 are successively stored in the region DATA2, and each matching data code is searched through the right side regions of the encryption table LUT. When the matching data code is found, an encryption code to be paired with in the left side regions is stored in the region DATA1. The encryption code stored in the region DATA1 is transmitted outside through the internal bus 170, the transmission circuit 132 and the antenna 120.

Operation to Write Data Code

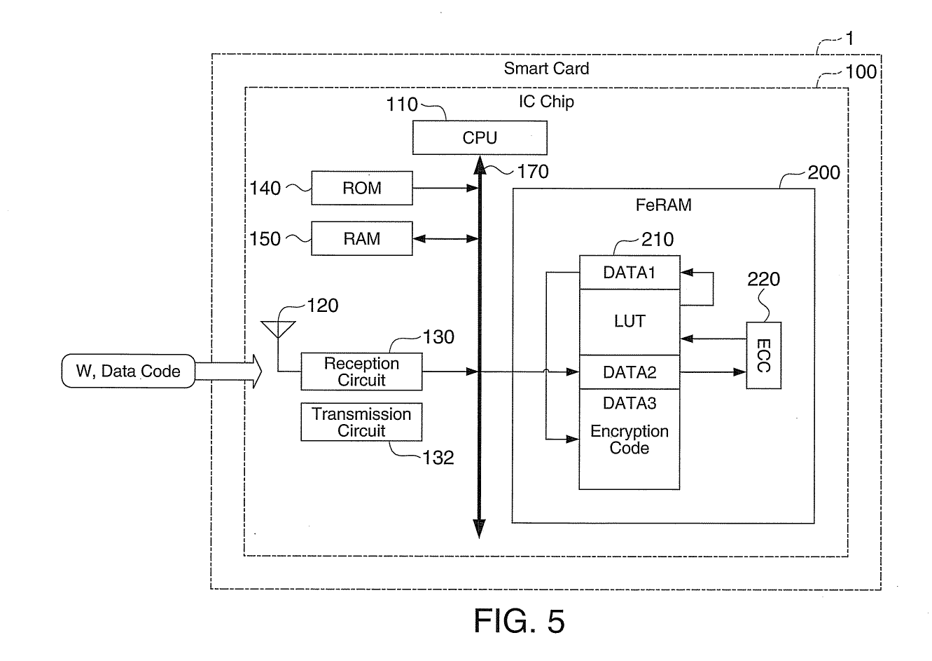

Next, an operation to write a data code is described with reference to FIG. 5. FIG. 5 is a block diagram for describing an operation to write a data code.

As shown in FIG. 5, when a write command W and a data code are sent from outside, the data code is transferred and stored in the region DATA2 of the data storage region 210 of the FeRAM 200 through the antenna 120, the reception circuit 130 and the internal bus 170. The data code stored in the region DATA2 is checked with ECC 220 if it is correct; and when it is correct, a matching data code is searched through the right side regions of the encryption table LUT. When the matching data code is found, an encryption code to be paired with in the left side regions is stored in the region DATA1. The encryption code stored in the region DATA1 is sequentially written to the region DATA3.

Operation to Read Data Code

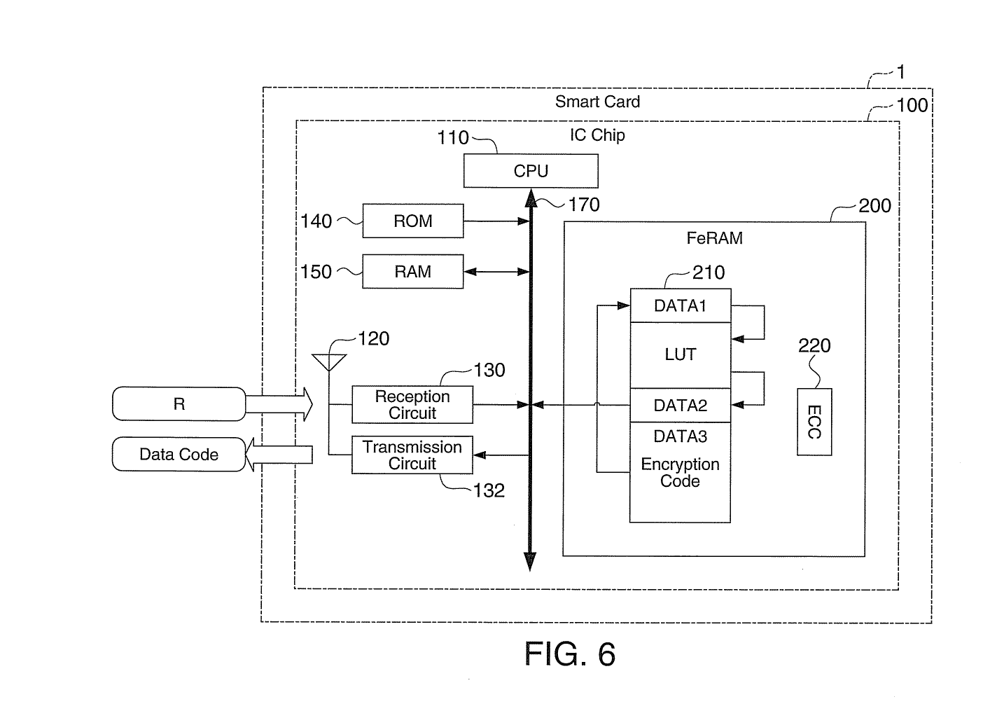

Next, an operation to read a data code is described with reference to FIG. 6. FIG. 6 is a block diagram for describing an operation to read a data code.

As shown in FIG. 6, when a readout command R is sent from outside, the readout command R is transferred through the antenna 120, the reception circuit 130 and the internal bus 170, and interpreted by the CPU 110. Then encryption codes stored in the region DATA3 of the data storage region 210 of the FeRAM 200 are successively stored in the region DATA1, and each matching encryption code is searched through the left side regions of the encryption table LUT. When the matching encryption code is found, a data code to be paired with in the right side regions is stored in the region DATA2. The data code stored in the region DATA2 is transmitted outside through the internal bus 170, the transmission circuit 132 and the antenna 120.

Operation to Rewrite LUT

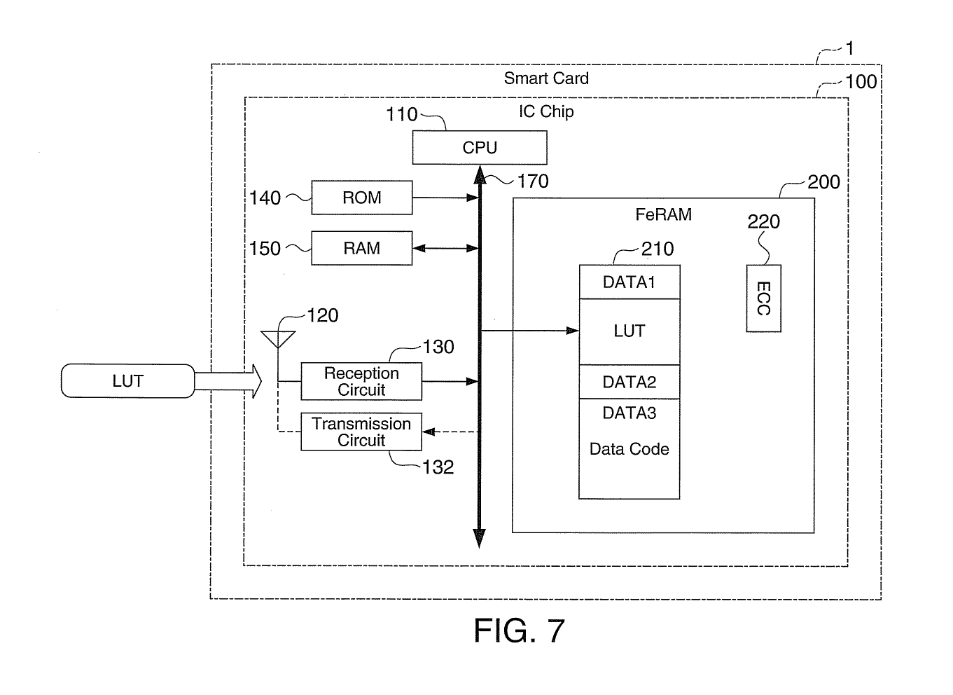

Next, an operation to rewrite the encryption table LUT is described with reference to FIG. 7. FIG. 7 is a block diagram for describing an operation to rewrite the encryption table LUT.

As shown in FIG. 7, when information for rewriting the encryption table LUT is sent from outside, the information is sent through the antenna 120, the reception circuit 130 and the internal bus 170 to the encryption table LUT in the data storage region 210 of the FeRAM 200, and the encryption table LUT is rewritten.

According to the embodiments described above, the following effects can be obtained.

In accordance with the embodiments described above, the encryption table is written in the ferroelectric memory, and therefore can be readily rewritten, and data stored in the ferroelectric memory is difficult to be encrypted from outside. Accordingly, it is possible to provide a smart card without the risk of an encryption table stored in a ferroelectric memory being read from outside.

Embodiments of the invention are described above, but the invention is not limited to those embodiments at all, and many changes can be made and implemented in a variety of modes within the range that does not depart from the subject matter of the invention. Some of the modified examples are described below.

### MODIFIED EXAMPLE 1

Smart cards in accordance with Modified Example 1 of the invention are described. Electronic apparatuses that use the smart card 1 described in the first embodiment can be used in encryption data storage processing fields in diversified services with very low power consumption. For example, examples of the electronic apparatuses include ticket examination apparatuses at railroad stations, automatic vending machines, and automatic teller machines (ATM) at banks.

### MODIFIED EXAMPLE 2

Smart cards in accordance with Modified Example 2 of the invention are described. In the first embodiment described above, a contactless smart card using the antenna 120, the reception circuit 130 and the transmission circuit 132 is described. However, a contact type smart card provided with terminals, instead of the antenna 120, the reception circuit 130 and the transmission circuit 132, may also be provided.

What is claimed is:

1. A semiconductor device comprising:
a rewritable ferroelectric memory including an encryption table containing one or more data codes paired with encryption codes that are the data codes encrypted, a first region for storing the encryption codes, a second region for storing the data codes, and a third region for storing one or more of the data codes, wherein, when the encryption code is stored in the first region, the encryption table is searched through and the data code pairing with the encryption code is outputted to the second region, and when the data code is stored in the second region, the encryption table is searched through and the encryption code paring with the data code is outputted to the first region;
a reception section that receives from outside a command code and the encryption code; and
a transmission section that transmits outside the encryption code,
wherein, upon receiving from outside a write command as the command code and the encryption code at the reception section, the encryption code received is inputted to the first region, and the data code paired with the encryption code outputted from the second region is written to the third region; and upon receiving from outside a readout command as the command code at the reception section, a specified one of the data codes is read from the third region and inputted to the second region, the encryption code paired with the data code outputted from the first region is transferred to the transmission section, and the encryption code is transmitted outside from the transmission section.

2. A semiconductor device comprising:
a rewritable ferroelectric memory including an encryption table containing one or more data codes paired with encryption codes that are the data codes encrypted, a first region for storing the encryption codes, a second region for storing the data codes, and a third region for storing one or more of the encryption codes, wherein, when the encryption code is stored in the first region, the encryption table is searched through and the data code pairing with the encryption code is outputted to the second region, and when the data code is stored in the second region, the encryption table is searched through and the encryption code paring with the data code is outputted to the first region;
a reception section that receives from outside a command code and the data code; and
a transmission section that transmits outside the data code,
wherein, upon receiving from outside a write command as the command code and the data code at the reception section, the data code received is inputted to the second region, and the encryption code paired with the data code outputted from the first region is written to the third region; and upon receiving from outside a readout command as the command code at the reception section, a specified one of the encryption codes is read from the third region and inputted to the first region, the data code paired with the encryption code outputted from the second region is transferred to the transmission section, and the data code is transmitted outside from the transmission section.

3. A semiconductor device according to claim 1, further comprising an error correction circuit that corrects an error that possibly occurs on data stored in the ferroelectric memory.

4. A smart card comprising the semiconductor recited in claim 1.

5. An electronic apparatus comprising the smart card recited in claim 4.
